(19) United States
(12) Patent Application Publication
(10) Pub. No.: US 2013/0092335 A1
(43) Pub. Date: Apr. 18, 2013

(54) CELL DOOR WINDOW COVER AND METHODS FOR USING THE SAME

(71) Applicant: Danieray Johnsen, Rio Rancho, NM (US)

(72) Inventor: Danieray Johnsen, Rio Rancho, NM (US)

(21) Appl. No.: 13/272,126

(22) Filed: Oct. 12, 2011

(51) Int. Cl. E06B 7/28

(52) U.S. Cl. 160/405

(57) ABSTRACT

Apparatus and methods are disclosed for controlling inmates disposed in their cells during emergency situations. The apparatus of the present invention includes a flexible magnetic cover which can be used by staff as a temporary cover for prison cell door windows. The apparatus may be used to help limit the inmate's visualization of prison emergency responses. Modern prison cell door designs include a cell door window but do not include any means to block this window.

### BACKGROUND OF THE INVENTION

The present invention relates to inmate control apparatus and methods and, more particularly, to a device that may be used in prisons to cover inmate cell door windows during emergency situations.

In North America alone, the U.S. Bureau of Justice Statistics reports in 2009 that there are over 2,292,133 inmates incarcerated in U.S. prisons and jails. Emergency situations can occur inside inmate general and special housing units without notice. Emergency preparedness, training and proper tools are critical to restoring normal operations, protecting human life and property.

Twenty-first century correctional facilities designs 3^{rd} and 4^{th} generation facilities with steel doors having reinforced glass built into the door without a traditional metal cover. This design prevents escape, allows for natural and artificial lighting, as well as provides for direct and indirect inmate supervision by staff. Yet, experienced correctional professional realized the limitations of a window in the cell door during emergency situations.

Compliant inmates return to their cells and watch staff through the door windows as they perform their emergency activities. Many times, staff emergency response can prompt violent and angry outburst displays from other inmates locked inside their cells. Facilities may incur property damage, additional injury, or additional unplanned use of force incidents, which may have otherwise not been necessary if the inmates were not able to witness emergency activities occurring outside their cell.

As can be seen, there is a need for apparatus and methods for limiting the ability of inmates to view activities outside of their cell through their cell door window during emergency situations.

### SUMMARY OF THE INVENTION

In one aspect of the present invention, a method for temporarily limiting visibility through a window comprises removably affixing a flexible magnetic material onto a metal periphery of the window, wherein the flexible magnetic material blocks visibility through the window.

In another aspect of the present invention, a method for limiting an inmate's visibility through a detention room door window during an incident comprises removably affixing a flexible magnetic material onto a metal periphery of the window, wherein the flexible magnetic material blocks visibility through the window; and removing the flexible magnetic material once the incident is over.

In a further aspect of the present invention, a method for assisting in the control of inmates during an emergency situation comprises directing inmates into their cells during the emergency situation; and blocking view outside of the cell by removably affixing a flexible magnetic material onto a metal periphery of the window.

These and other features, aspects and advantages of the present invention will become better understood with reference to the following drawings, description and claims.

### BRIEF DESCRIPTION OF THE DRAWINGS

FIG. 1A is a front view of an exemplary embodiment of a prison cell door;

FIG. 1B is a front view of another exemplary embodiment of a prison cell door;

FIG. 1C is a front view of yet another exemplary embodiment of a prison cell door; and

FIG. 2 is a front view of a temporary cell door window blocking device according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides apparatus and methods for controlling inmates disposed in their cells during emergency situations. The apparatus of the present invention includes a flexible magnetic cover which can be used by staff as a temporary cover for prison cell door windows. The apparatus may be used to help limit the inmate's visualization of prison emergency responses. Modern prison cell door designs include a cell door window but do not include any means to block this window.

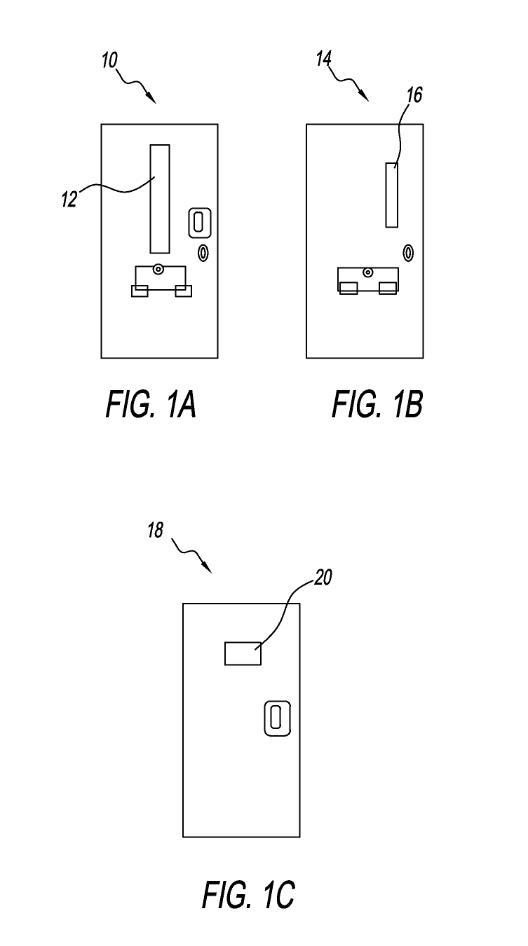

Referring to FIG. 1A, a prison cell door 10 may include a long vertical central window 12. Alternatively, as shown in FIG. 1B, a prison cell door 14 may include a vertical offset window 16. Furthermore, as shown in FIG. 1C, a prison cell door 18 may include a horizontal window 20. In either case, the window 12, 16, 20 may not include a means to block view through the window. Prior door designs include a hinged metal barrier that may be closed over the window. However, modern prison door design does not include such a metal door.

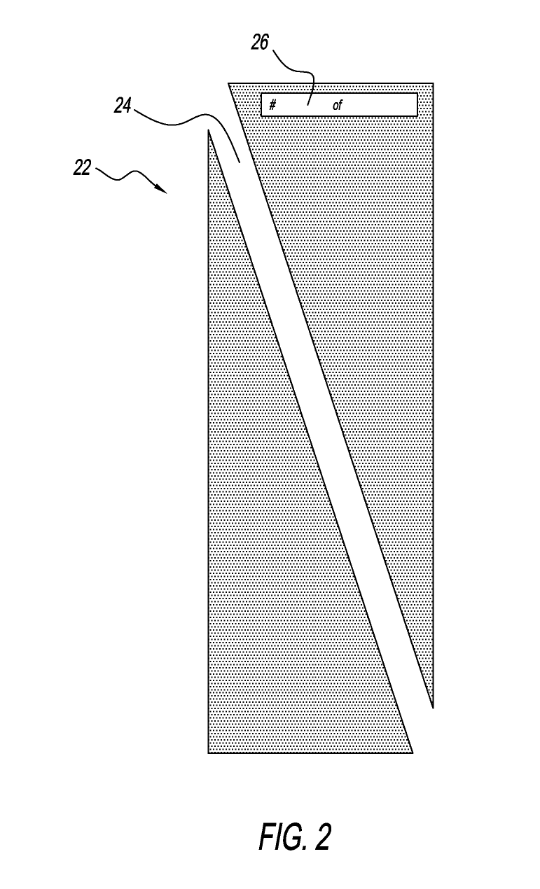

Referring to FIG. 2, a temporary window shield 22 may be a flexible magnet adapted to magnetically attach to at least a portion of an area framing the window 12, 16, 20. When the window shield 22 is in place, a person may not be able to see through the window. Such a window shield 22 may be especially useful where temporary blockage of a window in a metal door is beneficial. For example, the window shield 22 may be useful in a prison situation, where inmates inside cells may be blocked from visualizing activities outside of the cell. This may be especially useful in emergency situations, where an inmate witnessing an emergency response may respond violently. The window shield 22 may be used in other situations, such as on operating room doors, for emergency room door windows, and in other situations where temporary blocking of a window is desirable. The window shield 22 can also be used in mental hospitals, where a similar door design may be used. The window shield 22 could be used in any situation where people are confined for safety and security.

The window shield 22 may be of various thicknesses, such as 10 mil, 20 mil, 30 mil or 40 mil. The window shield 22 may be, for example, made of vinyl or rubber magnetic material. The window shield 22 may have a warning stripe 24 diagonally thereacross. The window shield 22 may be colored a dark, neutral color, whereas the warning stripe 24 may be colored a bright, contrasting color. For example, the window shield 22 may be black and the warning stripe 24 may be yellow.

The window shield 22 may include an inventory control item 26, such as a space having a first black and a second blank separated by the word “of”. In this manner, the window shields 22 may be consecutively numbered 1 of 100, 2 of 100, 3 of 100, and the like. This system may help track inventory of the window shields 22 in an institutional setting, for example.

The window shield 22 may be made by a variety of methods and of a variety of materials. In some embodiments, the color on the front of the window shield and the warming stripe 24 may be embossed on the flexible magnetic material. In other embodiments, the color and the warning stripe 24 may be a separate piece attached to the flexible magnetic material.

The window shield 22 may be applied to prison cell door windows to help control inmates during emergency situations. The window shield 22 may be used in methods to limit visualization through a window. The window shield 22 may, in a prison situation, for example, help reduce the possibility of retaliation from inmates and staff when they witness emergency responses. The window shield 22 may help protect emergency responders, reduce property damage by spectator inmates, ensure staff and inmate privacy during emergencies, eliminate violent psychological inmate trauma, ensure privacy during high profile movements, reduce costly inmate litigation, and the like. When an emergency situation is complete, staff may simple remove the window shield 22 from the windows, stack them together, and store them for future use.

It should be understood, of course, that the foregoing relates to exemplary embodiments of the invention and that modifications may be made without departing from the spirit and scope of the invention as set forth in the following claims.

What is claimed is:

1. A method for temporarily limiting visibility through a window, the method comprising:
removably affixing a flexible magnetic material onto a metal periphery of the window, wherein the flexible magnetic material blocks visibility through the window.

2. The method of claim 1, wherein the window is a window in a door.

3. The method of claim 1, wherein the window is a window in a prison cell door.

4. The method of claim 1, further comprising assigning an inventory control number with each of the flexible magnetic material disposed on each of the windows.

5. The method of claim 1, wherein an warning stripe is visibly viewable from one side of the window.

6. A method for limiting an inmate's visibility through a detention room door window during an incident, the method comprising:
removably affixing a flexible magnetic material onto a metal periphery of the window, wherein the flexible magnetic material blocks visibility through the window; and
removing the flexible magnetic material once the incident is over.

7. The method of claim 6, further comprising assigning an inventory control number with each of the flexible magnetic material disposed on each of the windows.

8. The method of claim 6, wherein an warning stripe is visibly viewable from one side of the window.

9. A method for assisting in the control of inmates during an emergency situation, the method comprising:
directing inmates into their cells during the emergency situation; and
blocking view outside of the cell by removably affixing a flexible magnetic material onto a metal periphery of the window.

10. The method of claim 9, further comprising removing the flexible magnetic material after the emergency situation is complete.

11. The method of claim 9, further comprising assigning an inventory control number with each of the flexible magnetic material disposed on each of the windows.

12. The method of claim 9, wherein an warning stripe is visibly viewable from one side of the window.
